(19) United States
(12) Patent Application Publication
(10) Pub. No.: US 2012/0078744 A1
(43) Pub. Date: Mar. 29, 2012

(54) Method for Sale of Goods and Services Over a Wide Area Network

(76) Inventor: Thomas Nguyen, San Diego, CA (US)

(21) Appl. No.: 12/890,500

(22) Filed: Sep. 24, 2010

(51) Int. Cl. G06Q 30/00

(52) U.S. Cl. 705/26.3

(57) ABSTRACT

A system for an online auction for bidders wishing to purchase offered products over a wide area network such as the Internet. Using a graphic interface bidders are continuously provided views of offered products and services using a graphically actuated electronic means for input of buyers bids. Bidders are allowed to place bids for the product or service during a finite period of time known only to the seller whereby the last bidder to have input a bid, at the termination point for the time period wins. Optionally, winning bidders, and in certain instances, losing bidders, may re-list an item won and attempt to resell it at a potential profit.

### FIELD OF THE INVENTION

The disclosed method relates to the sales of goods and services employing a wide area network. More particularly, it relates to the employment of an online auction for bidders wishing to purchase offered products. The method employs a graphic interface adapted for viewing on buyers' or bidders' computers. The interface continuously provides views of offered products and services and graphically actuated electronic means for input of buyers' bids over a network to a server of the offering vendor running the online auction. Bidders are allowed to place bids for the product or service during a finite period of time known only to the seller, whereby the last bidder to have input a bid, at the termination point for the time period, wins. Winning bidders, at their option, may take delivery of the product or service, or, re-list it on the site and resell it at a potential profit. Losing bidders may also qualify to participate in subsequent auctions for the product.

### BACKGROUND OF THE INVENTION

With the advent of the Internet, online sales of goods and services have become common place. In recent years, online auction sites have become a fixture of electronic commerce, for instance with sites such as EBAY providing buyers with an immense selection of goods and services to bid upon. Many auctions offer buyers with the potential of finding specialized goods and services at bargain prices. Because prices are not fixed, online buyers can purchase items at significant discounts to retail list prices. Auctions also offer sellers a benefit, in that the goods are sold with no fixed price and the competition among buyers or bidders can significantly increase the sales price.

However, participants in conventional online auctions face certain difficulties more recently. One of these problems comes from “sniping” which occurs when bidders wait until literally the last few seconds of an auction and increase their bid by a very small amount and win the item. This type of behavior upsets the conventional bidders and results in distorted prices paid to the seller from a conventional auction which continues until no more bids are placed. However, online bidding to millions of potential customers is not conducive to such real-time bidding and cessation methods.

An additional problem occurs in that conventional auction sites such as EBAY fail to excite the buyers in a fashion akin to live auctions, where bidders get caught up in the moment and increase prices. Instead, the duration of the auction time is fixed and bidders may return at any time before the cessation time to bid. Many bidders fail to return and, as noted above, other bidders simply wait until the last moment or employ a computer service to input a last minute bid, thereby lowering the potential selling price for the seller.

As such, there is an unmet need for an online auctioning method and system which will service to put the excitement back into the bidding process. Such a method should endeavor to eliminate the fixed time for bidding cessation which is such a problem with conventional auction sites and thereby impart a sense of urgency in bidders to immediately place bids. Such a site should also instill excitement in bidders by offering products and providing bidders the potential to purchase such products at huge discounts within the uncertain time frame of a conventional auction. Still further, such a method and system should provide winning bidders with the potential to reap profits from their participation by allowing them to sell products also. Finally, such an auction site should also instill some excitement in losing bidders by providing a means to qualify the losing bidder to also potentially profit by participating in profits from subsequent auctions for the products which they did not initially win.

Accordingly, it is an object of the present invention to provide a system and method for facilitating the sale of goods and services through an auction which electronically mimics the excitement and urgency of a conventional live auction.

It is an object of this invention to provide a method and system to offer bidders the potential for purchasing goods and services at huge discounts from retail pricing.

Further, it is another object of the present invention to provide bidders another reason for purchasing goods by providing the infrastructure to enable winning bidders to optionally make a potential profit on goods or services they have purchased at substantial savings by reselling them on the site.

Still further, it is an object of this invention to provide losing bidders with the potential to become qualified to participate in potential profits from subsequent auctions for products they did not win.

With respect to the above, before explaining at least one preferred embodiment of the system and method of holding online auctions herein in detail or in general, it is to be understood that the system and method herein is not limited in its application to the details of construction and to the arrangement of the components or the steps set forth in the following description or illustrated in the drawings. The various methods and combinations of methods and steps in the disclosed invention are capable of other embodiments, and of being practiced and carried out in various ways, all of which will be to those skilled in the art once the information herein is reviewed. Also, it is to be understood that the phraseology and terminology employed herein are for the purpose of description and should not be regarded as limiting.

As such, those skilled in the art will appreciate that the conception upon which this disclosure is based, may readily be utilized as a basis for designing and deploying a similar seller and bidder interface system and the like which are adapted for carrying out the several purposes of the present disclosed system. It is important, therefore, that the embodiments, objects and claims herein, be regarded as including any such equivalent methodology and operational infrastructures insofar as they do not depart from the spirit and scope of the present invention.

### SUMMARY OF THE INVENTION

The present invention provides a system for an online merchant or seller to offer goods and services to subscribing buyers or bidders at potentially huge savings. Concurrently, the system and method herein provide this buyer's potential for savings during an unknown time duration thereby setting a time for cessation of bidding which is unknown to the bidders thereby emulating a live auction where bidding only ceases when there are no more bids. Still further, the bidders bid in very small increments of money during this unknown time frame thereby encouraging immediate bidding by all participants to over bid any prior bid amount to win the auction.

Additional incentive is available by the provision of a qualification system for losing bidders to purchase the same product offered in the auction at a discount. This incentive is provided to losing bidders who qualify through their offering of a sufficient number of individual bids on the item auctioned during the duration of time the auction was held. Thus, all bidders are encouraged to bid continuously to maintain their status as qualified for a discount, should they happen to lose the auction on which they are bidding. All want to be the winner, but all bidders are also continuously reminded of their status as qualified or unqualified for a product discount, through the provision of a viewable graphic signal to each bidder as to their status at every moment during the auction. Thus, all bidders are reinforced continually, to enter bids to both win the auction, and, to maintain their ongoing status as qualified for a discount on products, should they happen to lose.

The disclosed method and system combines these aspects to create a sense of excitement and urgency amongst online participating bidders to drive the bids upward. In addition, the system plays upon the bidders sense of gain by allowing the winning bidder to subsequently re-list the item won for another auction where they may sell the product or service at a profit without ever taking possession of it physically and allowing qualified losing bidders to recoup their costs of bidding against a product purchase.

In a preferred mode of the system, software adapted to run on the seller's server and computers provides a graphic interface which may be transmitted over a network such as the Internet to each bidder's computer and display. The software is adapted to ascertain the identity of each bidder individually and allow them to individually input their bids during the duration allotted for the auction and to track the bidding and ascertain the high bidder or winner of each auction session.

The bidders, instead of bidding in actual dollars and cents, will bid in predetermined substantially equal individual increments of money. For example, bidders will bid in penny increments to overbid a previous bidder. They will purchase the increments, and right to bid them, prior to entering into a given auction. For instance, the bidder may purchase 100 individual penny increments at a price of sixty cents each. They will subsequently raise the bidding in any auction by one penny increments, thereby making the product or service being bid upon sound less expensive than it is to provide a means to encourage bidding and overbidding.

In a second concurrent means to encourage ongoing bidding amongst participants, the actual end of the duration of time were bids are to be accepted will be unknown to the bidders. Just as in a live bidding process, there is no end time, in each electronic bidding session, the bidders will not know if the auction ends in one minute or one hour. However, the bidder with the highest bid in increments at the moment of cessation of the auction will win. This unknown time duration will encourage bidders to submit multiple bids quickly in the increments they have pre-purchased. Otherwise the auction may end in a minute and they will not be the high bidder at that moment.

A third means to encourage bidding and higher prices to the seller is provided by the auction site granting winning bidders the right to re-list the item or service purchased, and gaining a profit on their purchase. The profit may be set by the auction site from all of the profit over what they paid in the auction, to a percentage over the price that they paid in the previous auction. Therefor the winning bidder may either take the product and have it shipped to them, or place it for sale with the hope of making a profit. The thought of purchasing an item at a deep discount, and then reselling it at a profit, without even taking possession, will thus encourage bidders to bid in a fast and furious manner during the unknown durations of auctions, thereby driving up the prices paid for merchandise or services.

Another means to encourage ongoing and continuous bidding is provided by software on the system calculating each individual bidder's immediate status as a qualified or unqualified bidder. All qualified bidders, who are not the winner at the cessation of the auction, are given the right to credit the aggregate total of their individual bids on the product at auction, as a credit toward the purchase of another product once the bidding ceases.

A graphic signal continuously viewable by each bidder continuously provides them with their status as qualified or unqualified during the auction. The interface will be easily visually discerned by each individual bidder such as having the bidder's screen name depicted in two different colors where a color change will signify loss of qualification.

Since qualification is based on the aggregate total value of all of the respective bids of each individual bidder, as a percentage of the total aggregate amount bid by all of the bidders, it is important that each bidder keep bidding.

Continuously bidding maintains their respective percentage of the totals of all bids, and their status as qualified for discounts, while cessation of bidding will allow the individual bidder's percentage of the bid total to slip and put their qualified status in jeopardy.

In another mode of rendering the duration of the auction to be variable, a time clock may be employed which resets at a new time duration each time a bid is received as long as the bid is placed prior to the lapse of the prior time period. In this mode, rather than just making the auction duration unknown, the remaining time would be rendered known by a clock display, but would change with each bid placed prior to the elapse of the time period. Subsequent time periods can be a few seconds to a few hours, thereby encouraging bidders to continue bidding in the hopes that a one or two second time period will follow their bid allowing them to win, and to maintain their qualified status should they lose.

Finally, in an additional means to provide potential gratification to even losing bidders, the method of operation of the system allows losing bidders, who at the time of the cessation of an auction they lost, were qualified to reap potential profits. Losing bidders heretofore in conventional auctions simply lost the item they were bidding upon and had no recourse.

In one mode of the method and system herein, wherein the losing bidders were not determined as qualified at cessation of the auction, are provided the option to purchase the product they were bidding upon at MSRP, minus the value of their bids and have the item shipped to them. This is optional of course but does provide the losers with some recompense in that the value of their bids was not wasted and was used toward buying the item they were bidding upon.

In another mode of the method herein, should the losing bidder be determined as qualified at cessation of the option, by the algorithm continually calculating the aggregate value of all bidders' individual bids, in relation to the auction bidding total, they may be given one or more options.

First, the qualified losing bidder may either purchase the item they were bidding upon at MSRP minus the value of their bids during the lost auction, and have it shipped to them. Alternatively, the qualified losing bidder may opt to become a seller-participants in a later auction for the item.

Should the qualified losing bidder wish to try and make a profit, by becoming a seller participant, they may purchase the same item as the item from the original auction which they lost, at MSRP, minus the value of their bids. Concurrently, the qualified losing bidder may request that the purchased item be re-auctioned in a subsequent loser participant auction.

If that subsequent auction yields aggregate total bids the value of which exceed MSRP, the losing bidder who is now a seller-participant, will get all the value of the original bids they advanced in the original auction refunded, plus a determined percentage of the bids which exceeded the MSRP (the profit). If however the subsequent seller-participant auction is not profitable, and the aggregate value of all bids are less than the MSRP, the qualified losing bidder participant will receive a refund of any funds they advanced to buy the item at MSRP, in excess of the value of their original bids in the original auction. Optionally, they may be credited some or all of the value of their original bids in the original auction toward bids to be used in the future.

In this fashion, all bidders are encouraged to bid continually in order to maintain their “qualified” status during the original auction, so that even if they lose, they will have options to regain the bids advanced, or to buy the item at MSRP, or to potentially make a profit on a subsequent auction for the same item.

### BRIEF DESCRIPTION OF THE DRAWINGS

The accompanying drawing which are incorporated in and form a part of this specification, illustrate embodiments of the invention and together with the description herein, serve to explain the general principles of this invention.

FIG. 1 depicts a simple box diagram of the basic procedure of the method herein.

FIG. 2 shows a more detailed view of the method herein with different outcomes possible for winning and losing bidders on each auction.

### DETAILED DESCRIPTION OF THE PREFERRED EMBODIMENTS

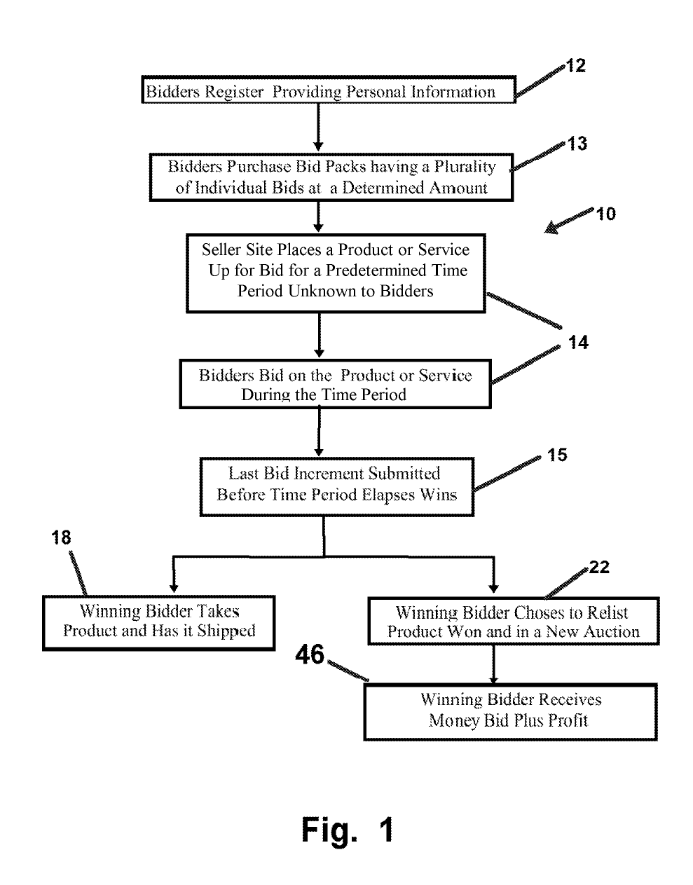

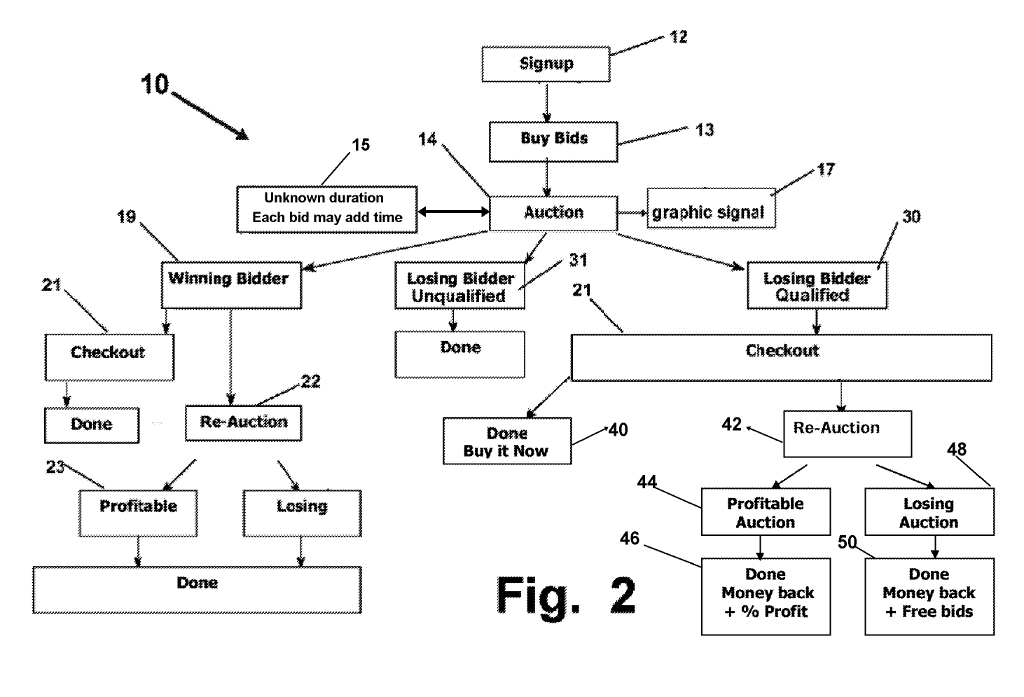

Referring now to the drawings, there is seen in FIGS. 1-2, modes of operation of the system 10 herein. In FIG. 1, the box chart depicts the basic steps of the method enabling the system 10 herein as would be employed using software adapted to the task, and a wired or wireless communications system.

The software is adapted to run on both the sellers server and the users or bidders remote computers to implement the methodology noted. The server and the remote computers are connected operatively over a wide area network such as the Internet. The software provides a means communicate and to display items for sale to bidders upon the bidder's video screen, and allow the bidders to track the individual auctions and bids and elapsed time for each such auction. The video screen need not necessarily be a PC or computer screen but may be any screen which is adapted to display the graphic interface communicated from the server of the seller, and which allows the user to execute commands to bid on the auction.

In a first step the software is also employed which is adapted to register 12 the bidders and to identify and track the respective individual bidders during bidding sessions of individual auctions 14.

The bidders will initially register 12 with the auction provider using a graphic interface provided over the network to their computer or other video display, from the server of the hosting seller or auction site. Subsequent to registering, bidders will have an ongoing ability to purchase bid packs 13, which are the ability to communicate individual bids in predetermined monetary increments such as a penny. In all auctions 14, a previous bid can only be raised by each subsequent bidder by one such monetary increment.

With bidders registered, and having bid increments to employ in individual auctions 14, the seller or auction site will place a product or service up for purchase in an individual auction 14 for a time duration 15 unknown to the bidders. As noted, in addition to having the time duration 15 unknown, it can also vary by adding short or long time allotment to the time duration 15 after each bid thereby making an unknown time more unknown. If the time duration 15 is unknown because additional time periods added with each bid, then a countdown clock moving toward zero time may be employed and more time added each time a bidder bids to generate a sense of urgency to bid.

Using the communicated graphic interface on their video display and a designator, such as a cursor controlled by a mouse, bidders will continually bid their bid increments in individual submissions during the finite time period 15 of the auction 14. The last bidder to submit a bid increment prior to cessation of the auction 14 which is for time period 15 of each individual auction 14 which is unknown to the bidders, will win the product or service offered in the individual auction 14 and become the winning bidder 19.

The winning bidder 19 in any such individual auction 14, optionally may be given the right to re-list 16 the item they have won the auction 14. Or they may simply take delivery 18 of the item they have won at a checkout 21. The right to re-auction 22 may be predetermined and offered as part of the original auction 14 to all bidders, or, it may be determined by the auction provider acting and seller, by a formula based on the actual value of the winning bidder's 19 total bids. Currently, a preferred formula is the total value of the bids as a percentage of the manufacturer's suggested list price (MSRP)of the item won. Of course some other calculation based on the value of the winning bidder's 19 bids may be employed as a means to encourage ongoing bidding in the original auction 14. If a winning bidder 19 chooses to re-list 16 the item, a subsequent re-auction 22 session is held with the won item as the prize for the bidders in that re-auction 22.

Winning bidders 19, should the item offered in the subsequent re-auction 22, draw bids where the total aggregate value of all bids by all bidders in the subsequent re-auction 22, is profitable 23 will profit. Profitable 23 is determined by the aggregate total of bids in the re-auction exceeding a set value amount determined by the auction provider. In this case, the winning bidder 19 will receive the value of their originally bid amount on the item, plus a percentage of any amount profitable 23 and exceeding the value amount set by the auction provider running the auction. Currently, a preferred set value to determine a profitable 23 outcome, is the MSRP, since all bidders can easily verify that amount independently. Thus, if the aggregate total actual value of all of the bids by subsequent bidders in the re-auction 22 exceeds the MSRP, the winning bidder 19 would receive the value of their original winning bid, plus a cut of the amount exceeding MSRP which is shared with the auction provider acting a seller. Currently, a preferred profit split is tendering the winning bidder 19 an amount in a range between 40-800 of the MSRP of the item or service in the re-auction 22.

However, in the re-auction 22, should the total aggregate actual value of all of the bids does not exceed the set value determined by the auction provider, then the winning bidder 19 would lose the item and the amount they originally bid in the original auction 14. Thus the winning bidder 19 takes a gamble.

As noted above all bidders are continuously encouraged to continue bidding, by the provision of a visual signal 17 on the graphic interface, as to their current status as qualified or unqualified based on the number and aggregate actual value of their bids during any auction. Currently, the visual signal preferred is a graphic depiction of indicia easily recognized by the bidder such as a color change of their screen name, or even the depiction of the word “qualified” or “unqualified” depending on the bidders status at that moment in time.

As noted the auction provider will employ software adapted to the task, to track each bidder and the aggregate total actual value and number of bids, and make a determination as to whether each bidder is qualified or unqualified at that moment. Since being qualified 30 is based on the aggregate total value of all of the respective bids of each individual bidder, as a percentage of the total aggregate amount bid by all of the bidders in the auction at that same moment, it is important that each bidder keep bidding to maintain a qualified 30 status.

In this step in the process all losing bidders who are qualified 30 at the cessation of the auction 14, are given the right to credit the aggregate total actual value of their individual bids on the product at auction 14, as a credit toward a purchase of another product from the auction provider at a checkout 21 step, once the bidding ceases. Losing bidders who are unqualified 31 at the moment of cessation of the auction 14, are finished and have lost the amount of their bids.

In this fashion, numerous means to encourage bidding during each individual auction 14 are provided through unknown time frames, the use of bid increments rather than money amounts, the chance for winning bidders 19 to re-auction 22 and sell the item at a profit, and the ability of qualified 30 losing bidders to use the value of their bids toward a product purchase at checkout 21.

A means to encourage all bidders on all auctions 14 to bid continually and frequently, is provided by the potential for profits or discounts available even to losing bidders who are still determined as qualified 30 at he cessation of any auction 14. Maintaining the qualified 30 status allows losing bidders options to potentially reap profits and to at least not lose the value of their bids on the original auction 14.

As shown in the chart of FIG. 2, in cases where losing bidders are not determined as being qualified 30 at cessation of the auction 14, such unqualified losing bidders 31 they are provided the option to purchase the product they were bidding upon at MSRP, minus the value of their bids and have the item shipped to them. This is optional of course but does provide the losing bidders with some recompense in that the value of their bids was not wasted and was usable toward buying the item they were bidding upon.

In another mode of the method herein, should the losing bidder be determined as qualified 30 at cessation of the auction 14, by the algorithm or other means to continually calculate the aggregate value of all bidders' individual bids, in relation to the auction bidding total, they may be given one or more options only available to qualified 30 losing bidders.

First, the qualified 30 losing bidder may either purchase 40 the item they were bidding upon at MSRP minus the value of their bids during the lost auction, and have it shipped to them. Alternatively, the qualified 30 losing bidder may opt to become a seller-participants in a later re-auction 42 for the item.

Should the qualified 30 losing bidder wish to try and make a profit, by becoming a seller participant in the re-auction 42, they may purchase the same item as the item from the original auction which they lost, at MSRP, minus the value of their bids. Concurrently the qualified losing bidder may request that the purchased item be re-auctioned 42.

If that subsequent re-auction 42 yields aggregate total bids the value of which exceed MSRP in a profitable auction 44, the losing bidder who is now a seller-participant, will receive all the value of the original bids they advanced in the original auction refunded, plus a determined percentage of the bids which exceeded the MSRP (the profit) 46. If however the subsequent re-auction 42 is not profitable 48, and the aggregate value of all bids are less than the MSRP, the qualified 30 losing bidder participant will receive a refund of any funds they advanced to buy the item at MSRP, in excess of the value of their original bids in the original auction 50 and optionally they may be credited some or all of the value of their original bids in the original auction, toward bids to be used in the future.

In this fashion, all bidders are encouraged to bid continually in order to maintain their “qualified” status during the original auction, so that even if they lose, they will have options to regain the bids advanced, or to buy the item at MSRP, or to potentially make a profit on a subsequent auction for the same item.

While all of the fundamental characteristics and features of the disclosed method of providing an online auction site having means to encourage multiple and increased bidding have been described herein, with reference to particular embodiments thereof, a latitude of modification, various changes and substitutions are intended in the foregoing disclosure and it will be apparent that in some instances, some features of the invention will be employed without the corresponding use of other features without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

What is claimed is:

1. A computer network based-system operative to facilitate commerce between a seller and bidders at an internet-based auction, comprising the steps of:
employing a data processor running software adapted to the task to operatively communicate over the internet with bidders, to register each bidder to said auction and create respective bidder profiles, using an online registration;
allowing each bidder who registers to purchase individual bid increments using online or remote means for tendering payments to said seller for said bid increments, said bid increments being of the same value thereby providing a means to equalize each bid advanced during a said auction by said bidders;
maintaining a database of registered bidder profiles, and a total number of bid increments held in individual bidder accounts, by each respective bidder;
employing said data processor to communicate information concerning items for sale in individual auctions, to individual bidder's remote computing devices;
allowing bidders to enter bids, only using said individual bid increments, during an auction during a time period having an unknown cessation;
identifying the last bidder to enter a said bid, before said cessation of said unknown time period as a winning bidder;
identifying the other respective bidders on said respective auction as losers;
deducting the bid increments bid by the winning bidder, and also the bid increments bid by each respective losing bidder, from their respective individual bidder accounts on said database; and
employing the bidder profile of the winner, to ascertain how to tender the item won by the winning bidder to the winning bidder.

2. The computer network based-system of claim 1 including the additional steps of:
communicating a countdown clock displayable on said bidder's computing devices which depicts a declining remaining duration of time for an individual auction; and
adding a period of time to the remaining duration of time depicted on said countdown clock, each time a bidder bids on said item.

3. The computer network based-system of claim 2 including the additional steps of:
varying the length of said period of time added to said remaining duration of time as a means to render said cessation of said auction substantially indescribable by bidders and to provide an incentive to all bidders to continue bidding.

4. The computer network based-system of claim 1 including the additional steps of:
providing said winning bidder with an option to resell the item won by said winning bidder in a subsequent re-auction; and
should the winning bidder opt to resell the item won in a said re-auction, splitting any profit on said item won between said winning bidder and said seller.

5. The computer network based-system of claim 2 including the additional steps of:
providing said winning bidder with an option to resell the item won by said winning bidder in a subsequent re-auction; and
should the winning bidder opt to resell the item won in a said re-auction, splitting any profit on said item won between said winning bidder and said seller.

6. The computer network based-system of claim 3 including the additional steps of:
providing said winning bidder with an option to resell the item won by said winning bidder in a subsequent re-auction; and
should the winning bidder opt to resell the item won in a said re-auction, splitting any profit on said item won between said winning bidder and said seller.

7. The computer network based-system of claim 1 including the additional steps of:
tracking the aggregate total of all said bids in said auction by all said bidders;
tracking each individual said bidder's aggregate total of bids;
designating bidders as qualified bidders, whenever a said individual bidder's aggregate total of bids advanced reaches a preset percentage of the said aggregate total of all said bids in said auction;
providing a visual cue displayable on said graphic interface, to said qualified bidders in said auction, during time periods in said duration of said auction where they have been determined as qualified bidders;
designating all said qualified bidders who at the moment of cessation of said auction, were determined as said qualified bidders, to be qualified losers;
providing said qualified losers an option to purchase an item substantially similar to the item for sale they lost at a fixed price, and to re-auction said purchased item; and
based on the value of said payments made to said seller for bid increments, by bidders when they purchased said bid increments, should the aggregate total of the value of the payments for all bid increments bid during the re-auction, exceed the manufacturer's suggested list price for said item, then providing a percentage of said aggregate total to said qualified loser, and concurrently refunding all said qualified loser's bid increments which they bid during the original said auction which they lost.

8. The computer network based-system of claim 2 including the additional steps of:
tracking the aggregate total of all said bids in said auction by all said bidders;
tracking each individual said bidder's aggregate total of bids;
designating bidders as qualified bidders, whenever a said individual bidder's aggregate total of bids advanced reaches a preset percentage of the said aggregate total of all said bids in said auction;
providing a visual cue displayable on said graphic interface, to said qualified bidders in said auction, during time periods in said duration of said auction where they have been determined as qualified bidders;
designating all said qualified bidders who at the moment of cessation of said auction, were determined as said qualified bidders, to be qualified losers;
providing said qualified losers an option to purchase an item substantially similar to the item for sale they lost at a fixed price, and to re-auction said purchased item; and
based on the value of said payments made to said seller for bid increments, by bidders when they purchased said bid increments, should the aggregate total of the value of the payments for all bid increments bid during the re-auction, exceed the manufacturer's suggested list price for said item, then providing a percentage of said aggregate total to said qualified loser, and concurrently refunding all said qualified loser's bid increments which they bid during the original said auction which they lost.

9. The computer network based-system of claim 3 including the additional steps of:
tracking the aggregate total of all said bids in said auction by all said bidders;
tracking each individual said bidder's aggregate total of bids;
designating bidders as qualified bidders, whenever a said individual bidder's aggregate total of bids advanced reaches a preset percentage of the said aggregate total of all said bids in said auction;
providing a visual cue displayable on said graphic interface, to said qualified bidders in said auction, during time periods in said duration of said auction where they have been determined as qualified bidders;
designating all said qualified bidders who at the moment of cessation of said auction, were determined as said qualified bidders, to be qualified losers;
providing said qualified losers an option to purchase an item substantially similar to the item for sale they lost at a fixed price, and to re-auction said purchased item; and
based on the value of said payments made to said seller for bid increments, by bidders when they purchased said bid increments, should the aggregate total of the value of the payments for all bid increments bid during the re-auction, exceed the manufacturer's suggested list price for said item, then providing a percentage of said aggregate total to said qualified loser, and concurrently refunding all said qualified loser's bid increments which they bid during the original said auction which they lost.

10. The computer network based-system of claim 4 including the additional steps of:
tracking the aggregate total of all said bids in said auction by all said bidders;
tracking each individual said bidder's aggregate total of bids;
designating bidders as qualified bidders, whenever a said individual bidder's aggregate total of bids advanced reaches a preset percentage of the said aggregate total of all said bids in said auction;
providing a visual cue displayable on said graphic interface, to said qualified bidders in said auction, during time periods in said duration of said auction where they have been determined as qualified bidders;
designating all said qualified bidders who at the moment of cessation of said auction, were determined as said qualified bidders, to be qualified losers;
providing said qualified losers an option to purchase an item substantially similar to the item for sale they lost at a fixed price, and to re-auction said purchased item; and
based on the value of said payments made to said seller for bid increments, by bidders when they purchased said bid increments, should the aggregate total of the value of the payments for all bid increments bid during the re-auction, exceed the manufacturer's suggested list price for said item, then providing a percentage of said aggregate total to said qualified loser, and concurrently refunding all said qualified loser's bid increments which they bid during the original said auction which they lost.

11. The computer network based-system of claim 5 including the additional steps of:
tracking the aggregate total of all said bids in said auction by all said bidders;
tracking each individual said bidder's aggregate total of bids;
designating bidders as qualified bidders, whenever a said individual bidder's aggregate total of bids advanced reaches a preset percentage of the said aggregate total of all said bids in said auction;
providing a visual cue displayable on said graphic interface, to said qualified bidders in said auction, during time periods in said duration of said auction where they have been determined as qualified bidders;
designating all said qualified bidders who at the moment of cessation of said auction, were determined as said qualified bidders, to be qualified losers;
providing said qualified losers an option to purchase an item substantially similar to the item for sale they lost at a fixed price, and to re-auction said purchased item; and
based on the value of said payments made to said seller for bid increments, by bidders when they purchased said bid increments, should the aggregate total of the value of the payments for all bid increments bid during the re-auction, exceed the manufacturer's suggested list price for said item, then providing a percentage of said aggregate total to said qualified loser, and concurrently refunding all said qualified loser's bid increments which they bid during the original said auction which they lost.

12. The computer network based-system of claim 6 including the additional steps of:
tracking the aggregate total of all said bids in said auction by all said bidders;
tracking each individual said bidder's aggregate total of bids;
designating bidders as qualified bidders, whenever a said individual bidder's aggregate total of bids advanced reaches a preset percentage of the said aggregate total of all said bids in said auction;
providing a visual cue displayable on said graphic interface, to said qualified bidders in said auction, during time periods in said duration of said auction where they have been determined as qualified bidders;
designating all said qualified bidders who at the moment of cessation of said auction, were determined as said qualified bidders, to be qualified losers;
providing said qualified losers an option to purchase an item substantially similar to the item for sale they lost at a fixed price, and to re-auction said purchased item; and
based on the value of said payments made to said seller for bid increments, by bidders when they purchased said bid increments, should the aggregate total of the value of the payments for all bid increments bid during the re-auction, exceed the manufacturer's suggested list price for said item, then providing a percentage of said aggregate total to said qualified loser, and concurrently refunding all said qualified loser's bid increments which they bid during the original said auction which they lost.

13. The computer network based-system of claim 7 including the additional steps of:
providing a refund of funds advanced by said qualified loser to purchase said item for re-auction, should said aggregate value of said payments for said bid increments bid during said re-auction be less than said manufacturer's suggested list price for said item.

14. The computer network based-system of claim 8 including the additional steps of:
providing a refund of funds advanced by said qualified loser to purchase said item for re-auction, should said aggregate value of said payments for said bid increments bid during said re-auction be less than said manufacturer's suggested list price for said item.

15. The computer network based-system of claim 9 including the additional steps of:
providing a refund of funds advanced by said qualified loser to purchase said item for re-auction, should said aggregate value of said payments for said bid increments bid during said re-auction be less than said manufacturer's suggested list price for said item.

16. The computer network based-system of claim 10 including the additional steps of:
providing a refund of funds advanced by said qualified loser to purchase said item for re-auction, should said aggregate value of said payments for said bid increments bid during said re-auction be less than said manufacturer's suggested list price for said item.

17. The computer network based-system of claim 11 including the additional steps of:
providing a refund of funds advanced by said qualified loser to purchase said item for re-auction, should said aggregate value of said payments for said bid increments bid during said re-auction be less than said manufacturer's suggested list price for said item.

18. The computer network based-system of claim 12 including the additional steps of:
providing a refund of funds advanced by said qualified loser to purchase said item for re-auction, should said aggregate value of said payments for said bid increments bid during said re-auction be less than said manufacturer's suggested list price for said item.
